(19) United States
(12) Patent Application Publication
(10) Pub. No.: US 2006/0253421 A1
(43) Pub. Date: Nov. 9, 2006

(54) Method and product for searching title metadata based on user preferences

(76) Inventors: Fang Chen, Peakhurst Heights (AU); Wanqing Li, Oatley (AU)

Correspondence Address: MOTOROLA, INC., 1303 EAST ALGONQUIN ROAD, IL01/3RD, SCHAUMBURG, IL, 60196, US

(21) Appl. No.: 11/123,351

(22) Filed: May 6, 2005

(51) Int. Cl. G06F 17/30

(52) U.S. Cl. 707/2

(57) ABSTRACT

A method and computer program product for searching metadata based on user preferences is useful for improving the efficiency of searches. According to the method, a search in a database for a set of one or more search parameters is performed, where the database includes a set of metadata attributes (step 305). Ranked search results are then obtained from the search for the set of one or more search parameters based on an aggregated user preference variable derived from the set of metadata attributes (step 325). Performing the search may include generating a plurality of search queries based on the set of one or more search parameters (step 310). Based on the aggregated user preference variable, each query in the plurality of search queries may be ranked (step 315). Finally, at least one query in the plurality of search queries is executed according to rank (step 320).

### FIELD OF THE INVENTION

The present invention relates generally to a method and computer program product for searching metadata based on user preferences, and in particular, although not exclusively, to using user annotations of content to improve user preference data.

### BACKGROUND OF THE INVENTION

Metadata may be defined as data that catalogs or describes aspects of other data. Metadata forms a part of many information management processes that enable a large quantity of information to be readily structured, searched and organized so that it can be efficiently converted into knowledge that is useful to an end user. Examples of metadata include keywords used to identify web page content on the Internet. Also, multimedia collections often include metadata annotations to assist in searching and cataloging numerous files of audio and video content.

The vast amounts of multimedia content that are accessible over the Internet using various types of devices including mobile phones and personal digital assistants (PDAs) have spawned the concept of Universal Multimedia Access (UMA). UMA concerns seamless and rapid delivery to end users of multimedia data, where delivery of the data is customized to the parameters and needs of an end user environment. Standardized procedures for the creation of metadata are important to the success of any UMA system, because a predictable structure for metadata can greatly improve content searching efficiency.

Effective data search techniques for efficiently locating desired content is critical in a UMA environment and in other environments such as content collections managed by private entities and individuals. In most prior art search techniques, search terms and queries are formulated based on an assumption that content consumers are different from content creators. That means that the process of organizing content and creating metadata annotations is generally completely isolated from the process of later searching the metadata to retrieve specific content. Such an assumption is usually reasonable concerning content that is accessible by the public over the Internet, as content consumers may be located anywhere in the world and are likely to have no close connections with the content creators. However, in other situations content consumers may share many circumstances, backgrounds, and predilections. That is particularly true of private content collections, owned by individuals and organizations, where the same people both create metadata annotations and later search the same annotations to locate specific content.

### SUMMARY OF THE INVENTION

According to one aspect, the present invention is therefore a method for searching metadata based on user preferences. The method includes performing a search in a database for a set of one or more search parameters, where the database includes a set of metadata attributes. Ranked search results are then obtained from the search for the set of one or more search parameters based on an aggregated user preference variable derived from the set of metadata attributes. Thus idiosyncratic behavior of a user during annotation of content in the database, can be used to improve knowledge about that particular user's preferences.

According to another aspect, the present invention includes the above method for searching metadata based on user preferences, and where the step of performing a search in a database for a set of one or more search parameters includes generating a plurality of search queries based on the set of one or more search parameters. Next, based on the aggregated user preference variable, each query in the plurality of search queries is ranked. At least one query in the plurality of search queries is then executed in order of rank. Thus search queries may be ranked before they are executed, which can provide an automatic ranking of results and can save time and processing resources by enabling higher ranked queries to be executed first and lower ranked queries to be executed later or not at all.

According to still another aspect, the present invention is a computer program product that includes a computer useable medium, such as a CD ROM, and computer readable code embodied on the computer useable medium for searching metadata based on user preferences. The computer readable code includes computer readable program code devices configured to cause the computer to effect the performing of a search in a database for a set of one or more search parameters, where the database includes a set of metadata attributes. Also included are computer readable program code devices configured to cause the computer to effect the obtaining of ranked search results from the search for the set of one or more search parameters based on an aggregated user preference variable derived from the set of metadata attributes. Finally, computer readable program code devices are also configured to cause the computer to effect the providing of the ranked search results to a user.

### BRIEF DESCRIPTION OF THE DRAWINGS

In order that the invention may be readily understood and put into pratical effect, reference will now be made to a specific embodiment as illustrated with reference to the accompanying drawings, wherein like reference numbers refer to the like elements, in which:

FIG. 1 is a schematic diagram that illustrates two different techniques for acquiring user preferences for search results;

FIG. 2 is a schematic diagram illustrating the generation of ranked search queries according to an embodiment of the present invention; and

FIG. 3 is a flow diagram that summarizes a method 300 for searching metadata based on user preferences according to an embodiment of the present invention.

### DETAILED DESCRIPTION

In the following detailed description, a specific embodiment of the present invention is described in sufficient detail to enable those skilled in the art to practice the invention and it is to be understood that other embodiments may be utilized and that structural changes may be made without departing from the scope of the present invention. The following detailed description is, therefore, not to be interpreted in a limited sense.

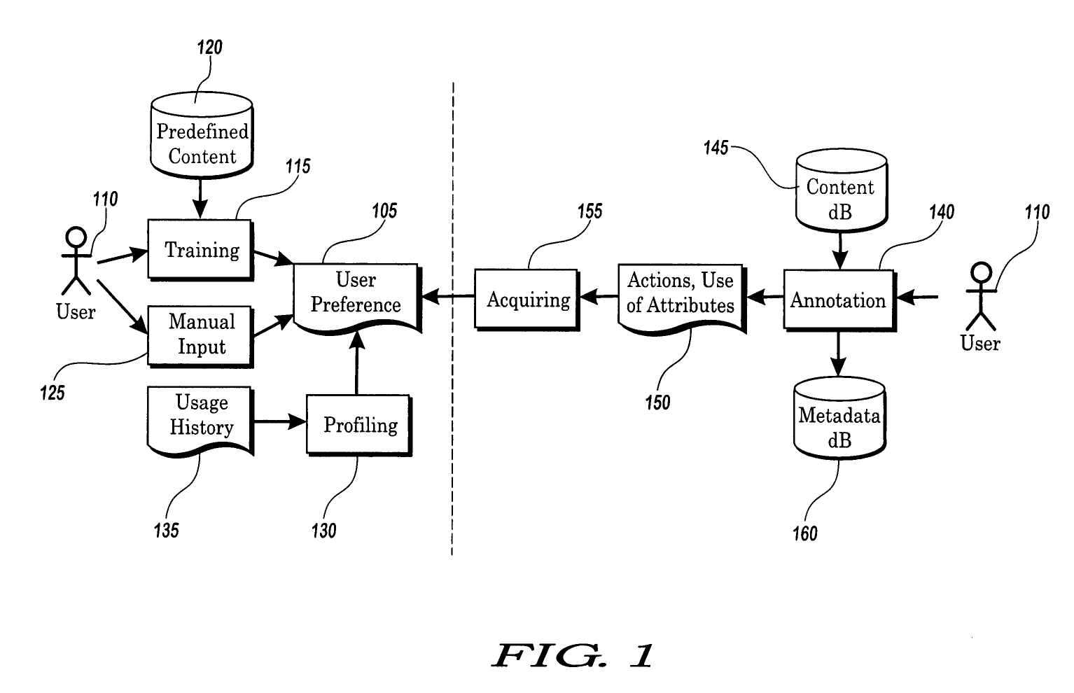

Referring to FIG. 1 there is a schematic diagram that illustrates two different techniques for acquiring user preferences for search results. The left side of FIG. 1 illustrates standard techniques according to the prior art. Here, user preference data 105 for a specific user 110 is acquired by various means. First, the user 110 may define his or her user preferences for specific types of search results by following a training process 115 based on predefined search content 120. Second, the user 110 may manually indicate preferences through a manual preference input process 125. Third, a user profiling process 130 may extract user preferences by analysing usage history data 135 concerning the user 110. Those skilled in the art will recognize that most prior art personalized Internet search engines follow one or more of the above processes.

The right side of FIG. 1 illustrates a technique according to an embodiment of the present invention where user preference data 105 for a user 110 is generated based on an analysis of an annotation process 140 performed by the same user 110. Here the annotation process 140 involves creating and assigning metadata to a raw content database 145 to create a metadata content database 160. Based on idiosyncratic data 150 concerning how the user 110 assigned the metadata to the raw content database 145, a user preference acquiring process 155 results in additional user preference data 105.

Most prior art techniques thus assume that there is no relation between searchable content creators and subsequent authors of search queries. However that is not always true, as sometimes a creator of searchable content is the same user 110 who subsequently authors a query for searching that content. The present invention exploits such circumstances in order to achieve better search results. Better search results are achievable because a given user 110 who demonstrates repeated behavioral idiosyncracies during a content annotation process, is very likely to repeat such idiosyncratic behavior when formulating a subsequent search routine of that content.

For purposes of the user preference acquiring process 155, those skilled in the art will appreciate that the user 110 may be an individual, a group of individuals or even a large organization. Regardless of the type of user 10, valuable user preference data 105 can be created from the user preference acquiring process 155 as long as the user 110 performs the annotation process 140 in an idiosyncratic manner that demonstrates preferences of the user 10. For example, consider an individual user 110 who annotates his personal home video collection by assigning metadata fields designated as “title,” “creator,” and “date” to each segment of video in the collection. If the user 110 frequently assigns one particular person's name, such as “smith”, in the metadata field “creator”, then the user preference acquiring process 155 according to an embodiment of the present invention would recognize that idiosyncrasy. Thus in a later search of the metadata by the same user 110 for the keyword “smith,” the user preference data 105 would indicate that the user 110 is more likely to be interested in search hits from the metadata field “creator” than from search hits in the other metadata fields. Similarly, if the user 110 is defined as a large organization, and members of the organization as a group demonstrate the same idiosyncratic behavior when annotating content, then user preference data 105 that is acquired from any one member of the organization will be relevant to searches performed by any other member of the organization.

As another specific example of the present invention, assume that A=(a₁, a₂, . . . , a_{L}) is a set containing all L metadata attributes defined in some metadata content concerning a personal video collection. Also assume that P=(p₁, p₂, . . . , p_{N}) represents an aggregated user preference variable or vector for a user 110, where p₁ is a weighting element between zero and one and indicates the likelihood that the user 110 will use a specific attribute, aᵢ, during an annotation and/or search.

Next assume that A=(title, genre, creator, date, production, event), and that for the particular user 110 P=(0.9, 0.9, 0.6, 0.7, 0.0, 0.2). That means that the user 110 used, during an annotation process that created the metadata content, the metadata attributes “title” and “genre” more frequently than the other attributes and never used the attribute “production”.

P may be determined as follows. Assume there are Nvideo segments in the content collection that the user has annotated using the attributes in A. Next let (n₁, n₂, . . . , n) be the number of times, respectively, that the attributes A=(a₁, a₂, a_{L}) were used. Then P may be defined as:

$$P = ( \frac{{n}_{1}}{N} , \frac{{n}_{2}}{N} , … , \frac{{n}_{L}}{N} ) . \qquad Eqn . 1$$

As suggested in FIG. 1, where the left and right sides of the figure both provide input to the user preference data 105, user preferences acquired from annotation according to the present invention can be aggregated with other preferences learned from conventional approaches. The preferences are then represented in a compatible fashion. For example, let U=(u₁, u₂, . . . , u_{L}) be an aggregated user preference variable learned from conventional approaches, and let P=(p₁, p₂, . . . , p_{L}) be an aggregated user preference variable derived from annotation according to an embodiment of the present invention. A new aggregated user preference variable may then be defined as follows:
P^{new}=(p₁^{new},p₂^{new}, . . . , p_{L}^{new}), Eqn. 2
where pᵢ^{new}=uᵢpᵢ. Thus if U=(1.0, 0.8, 0.5, 0.7, 0.0. 0.5) and P=(0.9, 0.9, 0.6, 0.7, 0.0, 0.2), then P^{new}=(0.9, 0.72, 0.3, 0.49, 0.0, 0.1). Alternatively other formulas for defining user preference variables, such as using maximum or minimum elements from individual user preference variables, can be used to define new aggregated user preference variables. An aggregated user preference variable is thus defined as any type of variable, including multidimensional variables or vectors, that defines a user preference for content identified by a particular metadata attribute.

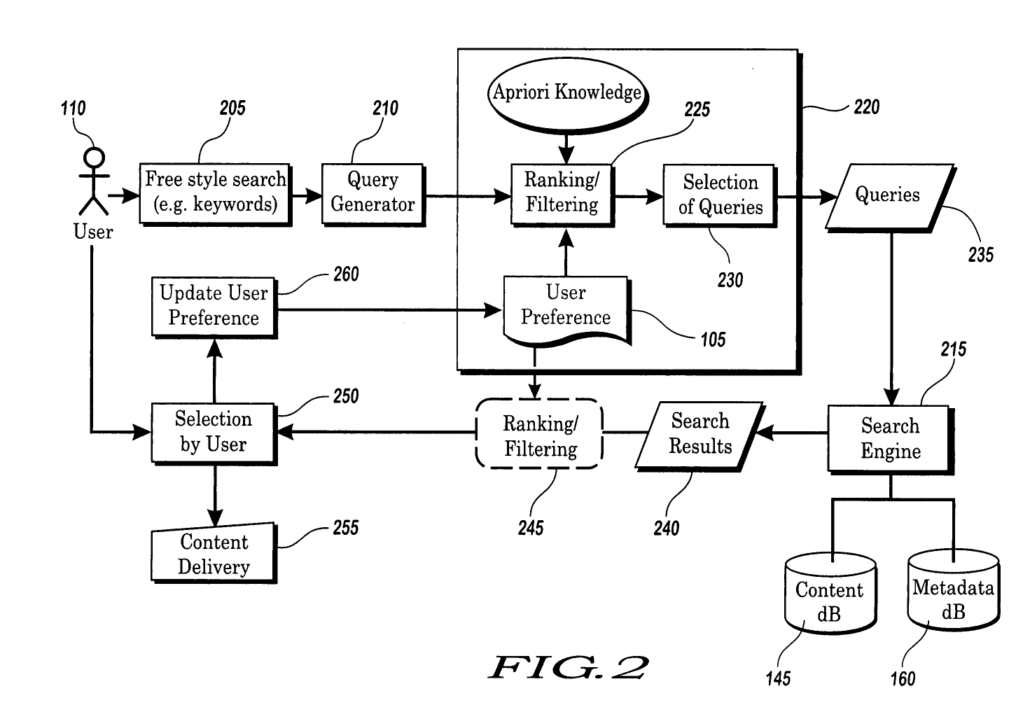

Referring to FIG. 2 there is a schematic diagram that illustrates a further embodiment of the present invention involving the generation of ranked search queries. During a search creation process 205 a user 110 may generate freestyle search parameters in order to conduct a search of a raw content database 145. The search parameters may include for example keywords, date parameters or other Boolean logic parameters. Next a query generator process 210 generates a list of specific search queries that will need to be executed to complete a search of the content database 145. According to the methods of the prior art, the search queries would then simply be executed by a search engine 215. However, according to the present invention, the box 220 in FIG. 2 illustrates additional preparatory steps that can result in a much more efficient delivery of search results to the user 110.

According to an embodiment of the present invention, a query ranking/filtering process 225 results in a ranking of the search queries that are output from the query generator process 210. The query ranking/filtering process 225 is based on either the user preference data 105, as defined by an aggregated user preference variable P, or by an apriori search parameter weighting variable wᵢ, or by both P and wᵢ. Apriori search parameter weighting variables are described in more detail below. After the query ranking/filter process 225, a query selection process 230 re-orders the search queries based on rank. The ranked and re-ordered search queries 235 are then input into the search engine 215.

Continuing a description of FIG. 2, the search engine 215 then searches the metadata content database 160 to identify specific content in the raw content database 145, and outputs search results 240. A results ranking/filtering process 245 is shown as a dashed box in FIG. 2 because it may not be necessary to further rank the search results 240. That is because the query ranking/filtering process 225 will automatically result in a ranked output. Next, a selection process 250 is performed where a user 110 selects from the search results 240 and then receives related content in a content delivery process 255. Finally, the selection process 250 may also enable a conventional user preference update process 260 that updates the user preference data 105.

To illustrate a further specific example of the present invention, let P=(0.9, 0.72, 0.3, 0.49, 0.0, 0.1) be an aggregated user preference variable with respect to metadata attributes A=(title, genre, creator, date, production, event). Now assume that a user is searching in a metadata database 160 for metadata that includes the keywords “Action” and “September”. Let K=(k₁, k₂), where k₁=“Action ” and k₂=“September”. According to the methods of the prior art one would then generate the following queries:

(“Action” <in> [title])∪(“Action” <in> [genre]) ∪
(“Action”<in>[creator]) ∪ (“Action” <in> [date])
(“Action” <in> [production])∪(“Action” <in> [event]) ∪
(“September” <in> [title])∪(“September” <in> [genre]) ∪
(“September”<in>[creator]) ∪(“September” <in> [date])
(“September” <in> [production])∪(“September” <in> [event]).

Following the formation of the above queries, according to the prior art one would then execute the queries in order and subsequently rank and filter the resulting output according to user preferences.

According to an embodiment of the present invention, the above example would result in the formulation of the same queries provided above; however the queries are then ranked before the queries are executed. That can result in significant time savings for a user I 10 and can conserve significant system resources. Thus according to the present example the above queries would be ranked as follows:

TABLE 1

| Ranked Query | Weighting Element |
|---|---|
| “Action” <in> [title] | 0.9 |
| “September” <in> [title] | 0.9 |
| “Action” <in> [genre] | 0.72 |
| “September” <in> [genre] | 0.72 |
| “Action” <in> [date] | 0.49 |
| “September” <in> [date] | 0.49 |
| “Action” <in> [creator] | 0.3 |
| “September” <in> [creator] | 0.3 |
| “Action” <in> [event] | 0.1 |
| “September” <in> [event] | 0.1 |
| “Action” <in> [production] | 0.0 |
| “September” <in> [production] | 0.0 |

The query rankings shown in Table 1 are particularly significant because they illustrate that according to an embodiment of the present invention, executing all of the queries shown in Table 1 is likely to be unnecessary. That is because the rankings based on the aggregated user preference variable P mean that it is most likely that the content sought by a user 110 will be found using only the top ranked queries. Thus an embodiment of the present invention may execute only the queries that obtain a high ranking or weighting element, such as for example 0.8 or better. In such case a user 110 may be returned search results from only the first two queries shown in Table 1.

Further, if one has apriori knowledge concerning the likelihood that a particular search parameter concerns a particular metadata attribute, then that knowledge can be combined with the user preference variable. Thus if it is known that the above keywords likely will be associated by a user 110 with particular metadata attributes, then as discussed above in reference to FIG. 2, that apriori knowledge can be aggregated as an apriori search parameter weighting variable similar to the aggregated user preference variable derived from a set of metadata attributes.

As an example of such apriori knowledge, consider a search parameter that is a date field. Generally a user 110 will use such a date field to find content that is associated with a metadata attribute that is also a date field; and it is unlikely that a user would use a search parameter that is a date field to find content that is associated with another type of metadata attribute, such as a name field. In such case an apriori search parameter weighting variable or vector would include a high-ranked weighting element for the date field metadata attribute and a low-ranked weighting element for the name field metadata attribute. An apriori search parameter weighting variable is thus defined as any type of variable, including multidimensional variables or vectors, that defines a likelihood that a particular search parameter will be associated with a particular metadata attribute.

Therefore, continuing with the above example, assume that an apriori search parameter weighting variable for the keyword “action” is w₁=(0.5, 0.9, 0.0, 0.0, 0.1, 0.2) and an apriori search parameter weighting variable for the keyword “September” is w₂=(0.5, 0.2, 0.0, 1.0, 0.0, 0.3). Then an aggregated preference for “Action” is (0.45, 0.65, 0.0, 0.0, 0.0, 0.02), which is the element by element product of w₁ and P; and the aggregated preference for “September” is (0.45, 0.14, 0.0, 0.49, 0.0, 0.03), which is the element by element product of w₂ and P. That results in the following ranked queries:

TABLE 2

| Ranked Query | Weighting Element |
|---|---|
| “Action” <in> [genre] | 0.63 |
| “September” <in> [date] | 0.49 |
| “Action” <in> [title] | 0.45 |
| “September” <in> [title] | 0.45 |
| “September” <in> [genre] | 0.14 |
| “September” <in> [event] | 0.03 |
| “Action” <in> [event] | 0.02 |
| “Action” <in> [date] | 0.0 |
| “Action” <in> [creator] | 0.0 |
| “September” <in> [creator] | 0.0 |
| “Action” <in> [production] | 0.0 |
| “September” <in> [production] | 0.0 |

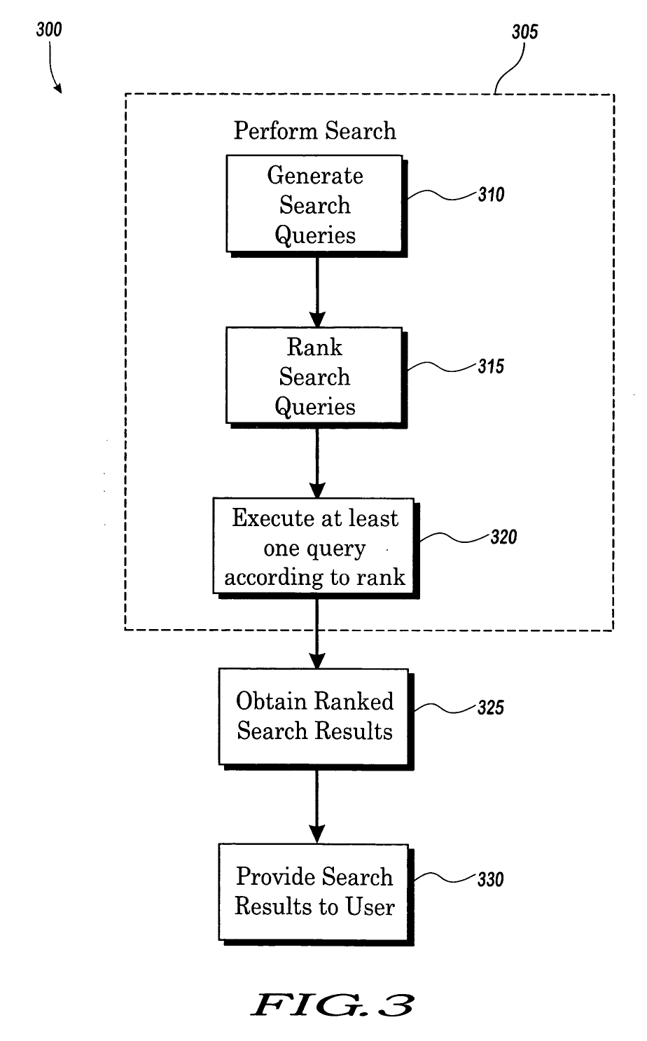

Referring to FIG. 3 there is a flow diagram that summarizes a method 300 for searching metadata based on user preferences according to an embodiment of the present invention. The metadata may be included in a database that also includes a set of metadata attributes that are derived from user-created metadata annotations. At step 305 a search is performed in the database for a set of one or more search parameters. The search parameters may be based on an aggregated user preference variable that is derived from the set of metadata attributes. Step 305 may include the following subsets: At step 310 a plurality of search queries based on a set of one or more search parameters is generated. Next, at step 315, each query in the plurality of search queries is ranked based on an aggregated user preference variable. At step 320 at least one query in the plurality of search queries is executed according to its rank. At step 325 ranked search results are obtained from the search for the set of one or more search parameters. Finally, at step 330, the ranked search results are provided to a user.

Those skilled in the art will recognize that the present invention may be embodied in a computer program product that includes a computer useable medium such as CD ROM, hard disk or other memory device. The computer useable medium includes computer readable code that executes the above described steps of the method 300.

In summary, advantages of particular embodiments of the present invention include superior search performance based on improved user preference data 105. Superior search performance is achievable because a given user 110 who demonstrates repeated behavioral idiosyncracies during a content annotation process, is very likely to repeat such idiosyncratic behavior when formulating subsequent search parameters for the content annotations. The improved user preference data 105 thus includes information about such idiosyncratic behavior of specific users 110. Further, the present invention enables apriori knowledge of search parameters, such as specific keywords, to rank search queries before the queries are executed. Such apriori knowledge of search parameters is also generally based on an analysis of an idiosyncratic annotation process performed by a specific user 110. The present invention thus enables more accurate search results to be provided to a user 110 more quickly. There is also no need to rank search results after a set of queries has been executed because ranking the queries before execution results in an automatic ranking of the results. Finally, the resources of a search engine 215 can be conserved according to the present invention because all of the queries associated with a particular set of search parameters do not always need to be executed; rather, only the top ranked queries—which queries are most likely to provide the preferred results sought by a user 110—may be executed.

The above detailed description provides a specific exemplary embodiment only, and is not intended to limit the scope, applicability, or configuration of the present invention. Rather, the detailed description of the specific exemplary embodiment provides those skilled in the art with an enabling description for implementing the specific exemplary embodiment of the invention. It should be understood that various changes can be made in the function and arrangement of elements and steps without departing from the spirit and scope of the invention as set forth in the appended claims.

We claim:

1. A method for searching metadata based on user preferences comprising the steps of:
performing a search in a database for a set of one or more search parameters, wherein the database includes a set of metadata attributes; and
obtaining ranked search results from the search for the set of one or more search parameters based on an aggregated user preference variable derived from the set of metadata attributes.

2. The method of claim 1 wherein the search parameters are selected from the group consisting of keywords, date parameters and other Boolean logic parameters.

3. The method of claim 1 wherein the aggregated user preference variable is a vector that includes a weighting element for each metadata attribute in the set of metadata attributes.

4. The method of claim 1 wherein the aggregated user preference variable is derived from user-created metadata annotations included in the database.

5. The method of claim 1 wherein the step of performing a search in a database for a set of one or more search parameters comprises:
generating a plurality of search queries based on the set of one or more search parameters;
ranking, based on the aggregated user preference variable, each query in the plurality of search queries; and
executing in order of rank at least one query in the plurality of search queries.

6. The method of claim 1 further comprising the step of:
providing an apriori search parameter weighting variable for each parameter included in the set of one or more search parameters, wherein the step of ranking the search results is based on one or both of the aggregated user preference variable and the apriori search parameter weighting variable.

7. The method of claim 6 wherein the step of performing a search in a database for a set of one or more search parameters comprises:
generating a plurality of search queries based on the set of one or more search parameters;
ranking, based on both the aggregated user preference variable and the apriori search parameter weighting variable, each query in the plurality of search queries; and
executing in order of rank at least one query in the plurality of search queries.

8. The method of claim 6 wherein the apriori search parameter weighting variable includes a weighting element for a specific parameter for each metadata attribute in the set of metadata attributes.

9. The method of claim 6 wherein the step of ranking the search results comprises providing an element by element product of the aggregated user preference variable and the apriori search parameter weighting variable.

10. The method of claim 1 wherein the aggregated user preference variable defines a frequency at which a particular metadata attribute was used during an annotation process.

11. A method for searching metadata based on user preferences comprising the steps of:
performing a search in a database for a set of one or more search parameters, wherein the database includes a set of metadata attributes;
obtaining ranked search results from the search for the set of one or more search parameters based on an aggregated user preference variable derived from the set of metadata attributes; and
providing the ranked search results to a user.

12. A computer program product comprising:
a computer useable medium and computer readable code embodied on the computer useable medium for searching metadata based on user preferences, the computer readable code comprising:
computer readable program code devices configured to cause the computer to effect the performing of a search in a database for a set of one or more search parameters, wherein the database includes a set of metadata attributes;
computer readable program code devices configured to cause the computer to effect the obtaining of ranked search results from the search for the set of one or more search parameters based on an aggregated user preference variable derived from the set of metadata attributes; and
computer readable program code devices configured to cause the computer to effect the providing of the ranked search results to a user.

13. The computer program product of claim 12 wherein the search parameters are selected from the group consisting of keywords, date parameters and other Boolean logic parameters.

14. The computer program product of claim 12 wherein the aggregated user preference variable is a vector that includes a weighting element for each metadata attribute in the set of metadata attributes.

15. The computer program product of claim 12 wherein the aggregated user preference variable is derived from user-created metadata annotations included in the database.

16. The computer program product of claim 12 wherein the devices configured to effect the performing of a search in a database for a set of one or more search parameters comprise:
computer readable program code devices configured to cause the computer to effect the generating of a plurality of search queries based on the set of one or more search parameters;
computer readable program code devices configured to cause the computer to effect the ranking, based on the aggregated user preference variable, of each query in the plurality of search queries; and
computer readable program code devices configured to cause the computer to effect the executing in order of rank of at least one query in the plurality of search queries.

17. The computer program product of claim 12 further comprising computer readable program code devices configured to cause the computer to effect the providing of an apriori search parameter weighting variable for each parameter included in the set of one or more search parameters, wherein the ranking of the search results is based on one or both of the aggregated user preference variable and the apriori search parameter weighting variable.

18. The computer program product of claim 17 wherein the devices configured to effect the performing of a search in a database for a set of one or more search parameters comprises:
computer readable program code devices configured to cause the computer to effect the generating of a plurality of search queries based on the set of one or more search parameters;
computer readable program code devices configured to cause the computer to effect the ranking, based on both the aggregated user preference variable and the apriori search parameter weighting variable, of each query in the plurality of search queries; and
computer readable program code devices configured to cause the computer to effect the executing in order of rank of at least one query in the plurality of search queries.

19. The computer program product of claim 17 wherein the apriori search parameter weighting variable includes a weighting element for a specific parameter for each metadata attribute in the set of metadata attributes.

20. The computer program product of claim 17 wherein the ranking of the search results comprises providing an element by element product of the aggregated user preference variable and the apriori search parameter weighting variable.
